(19) United States
(12) Patent Application Publication
(10) Pub. No.: US 2016/0050240 A1
(43) Pub. Date: Feb. 18, 2016

(54) SYSTEM AND METHOD FOR ENTITY STATUS

(71) Applicant: Isaac Teckie, San Jose, CA (US)

(72) Inventor: Isaac Teckie, San Jose, CA (US)

(21) Appl. No.: 14/799,637

(22) Filed: Jul. 15, 2015

Related U.S. Application Data
(60) Provisional application No. 62/038,218, filed on Aug. 16, 2014.

(51) Int. Cl. H04L 29/06

(52) U.S. Cl. CPC H04L 65/40; G06Q 50/01

(57) ABSTRACT

An entity status system for a marketplace communication comprising a client device and a computational device communicatively connected to the client device through a network. The computational device has a data store and an executing unit including a processor. The executing unit is configured to provide a user interface on the client device, allow an entity user or an administrator to upload updates related to a business life cycle of the entities and a marketplace information through the user interface to the data store and enables retrieval of the updates and the marketplace information from the data store for sharing with the customer users wherein the updates related to the business life cycle of the entities or the marketplace information enable the customer users to get the marketplace communication in real time.

### CROSS-REFERENCE TO RELATED APPLICATIONS

This application claims the benefit of U.S. Provisional Application No. 62038218 entitled “SYSTEM AND METHOD FOR ENTITY STATUS UPDATE” filed on 16 Aug. 2014, the contents of which are incorporated herein by reference.

### FIELD OF THE INVENTION

The present invention relates to the field of online status update. More particularly, the present invention relates to a system and methods for providing entity status updates regarding sequence of evolution that entities progress through in the marketplace.

### BACKGROUND OF THE INVENTION

Social media sites such as Twitter, Facebook, Google+, Yelp, CitySearch, LinkedIn, Yellow pages, Zagat, and the like have brought about means with which an entity can easily and at anytime communicate with a broad audience. The draw to communicating through social media is the ability for one entity to communicate with any individual or any of the other millions of individual entities and business entities that have registered accounts with a particular social media site.

In some social media sites, communication occurs by way of a message originator entering and posting a message to a site that is associated with the account that the message originator has registered at a particular social media site. By accessing the message originator site at the particular social media site, “friends” or entities that have a pre-existing relationship with the message originator can view the posted messages. Some social media sites allow the postings to be made public such that any entity that has an account at the particular social media site can access the site of the message originator to view the posted messages of the message originator. This however is a poor utilization of the messaging capabilities of social media, because viewers that are interested in the messages of the message originator have to actively seek out the messages that are posted by the message originator. In other words, a viewer first logs into its own account at the particular social media site and then the viewer navigates to the site of the message originator before being able to view the posted messages. A further issue with this form of communication is that posted messages/updates are missed or not viewed in real time by “friends” or entities. Further still, entities may be unable to view the posted messages/updates when the messages are restricted to viewing by “friends” or entities that have a preexisting relationship with the message originator. Lastly sales are not thought of happening in a social sphere. People don't want to mix social interactions/activities with business interaction/activities. Social media is positioned as communicating about social activities/interests with friends, family and the public.

To overcome some of these obstacles, some social media sites provide communication that occurs by way of a message originator entering and blasting a message to a set of specified recipients. This is typically accomplished by use of email messages, chat, or instant messages. This method of communication also has various shortcomings and similarly fails to realize the full messaging potential of communication media. Specifically, blasting messages to one's “friends” or entities for which a preexisting relationship already exists, is a poor conduit for sharing one's experiences with others that one does not have a preexisting relationship with. For example, blasting the update “We have Moved to a new place X” by an entity to one's “friends” would cause that message to only be read by those friends for which a preexisting relationship already exists. A random entity wanting to know to which place the said entity Moved would be unable to see that message and therefore the update would not be shared with others in the social media sphere. Similarly, a customer with no preexisting relationship would be unaware that such an update was posted by said entity and therefore would have a difficult time trying to ascertain the new location of said entity. The customer would lose time, and energy using systems not meant for communicating business status changes in a central location organized logically and simply. As a result, the customer might get frustrated and sales, goodwill and loyalty are damaged.

In addition, search engines are not always the most up-to-date. The Marketplace is littered with businesses and organizations that have a Grand Opening, that Close and that Move. This information is not readily available. Entities will update their information with the post-office to receive shipments/mailings but sometimes will wait until the very night of the move/after the organization has moved to notify the public with an 8×11.5 notice on their front door. The public becomes aware of the move by visiting the business. To find out that a business/organization has moved by visiting the business/organization is a waste of time, energy, money, gas and is very inconvenient and frustrating. Businesses will also update their website. The problem is there are too many websites and the changes are not easily found to make the search fruitful without a lot of time and energy expended to find their new Phone Number or their New Address. Customers do not always call a business just to see if the business is still operating. And there are too many businesses and not enough time to make that many phone calls a busy person to make. And a business will not be happy to pick up the phone to answer these types of questions. And customer cannot connect with business when their phone number has changed! Thus far there has not been a central convenient one-stop-shop location to find information about business' current life cycle status as they progress from one stage to the next and that is logically organized, easily accessible and with the business historical changes. The need to find historical information is also available making searching and finding information convenient and fruitful so there are greater savings for businesses and customers and businesses can increase their sales with “real-time” market intelligence changing updates.

Moreover, business directories and marketplace intelligence service providers are not focused on marketplace synergies toward fixing the inefficiencies in the marketplace both locally and globally. The marketplace is fragmented and there are lost business sales opportunities. Business transactions can be pursued more advantageously by service providers such as jobbers, construction companies, property management companies, Banking, Landscaping companies, Security Guard service providers, Recycling companies, Interior Designers, electricians, Lock-Smiths, plumbers, movers, HR service providers, business consultants and so on that will be able to find businesses that are in need of their services and provide the services the business owner wants or needs depending on their goals.

In view of the foregoing, it should be apparent that current means of marketplace communication is (1) fragmented; (2) improperly pushed through social media and (3) being ignored by business directories and market intelligence service providers and other data holders. Business directories, marketplace intelligence collectors and other data holders are poor conduits (1) for sharing updates with others that one does not have preexisting relationship with and (2) for informing/announcing the current status of an entity (3) solving marketplace fragmentation towards solving both business owners wants and needs and their customer's wants and needs to be informed in real-time. Accordingly, it would be advantageous to simplify and improve the process with which an entity can announce its business phase transitions also known as status update. One example of a useful announcement and sharing is the business' contact information: telephone, email, and URL. This announcement and sharing in a business environment will help solve issues that search engines do not always have the latest information of businesses and that not everyone will use social media to stay informed about businesses and there are too many business sites to visit to stay current in real-time. To that end, there is a need for the tracking of businesses throughout their life cycle in a logical central location as businesses transition from one phase into another and to communicate in “real-time” businesses (1) updated contact information and (2) their Status updates toward building communication synergies in the marketplace and increasing business transactions through efficiently and effectively meeting supply and demand.

Current systems for providing updates of entities do not allow for tracking the life cycle of businesses in “real-time”. As such, an interested person/entity cannot necessarily receive all relevant information of an entity in a timely manner. Current communication/distribution systems are currently out of sync and there doesn't seem to be a proper distribution channel in the form of Status Announcements that follow a logical and holistic life-cycle progression of entities in “REAL-TIME”. Therefore, needs exist for systems that provide status update information of entities in real or near-real time. Current systems for providing updates of entities further lacks voice of the community about what type of businesses move into the community, lack of speed in sharing/distributing information, lack of a central location where information can be found, searched, and for information to be shared in “Real-Time” speed.

### OBJECTS OF THE INVENTION

An object of the present invention is to provide a system and method for updating status of an entity as it progresses through its life cycle phases.

Another object of the present invention is to provide a system and method for entity status update that provides for display, distribution, notification, repository of an entity's complete life cycle progression in the marketplace.

Still another object of the present invention is to provide a system and method for entity status update that occurs in real time.

A further object of the present invention is to provide a system and method for entity status update which provides for ease of communication and distribution of messages by an entity.

A still further object of the present invention is to provide a system and method for entity status update which provides for relevance advertising/marketing by an entity.

Still another object of the present invention is to provide a system and method for entity status update which provides opportunity for increasing business transactions of an entity.

A further object of the present invention is to provide a system and method for entity status update which provides for repository where historical data by name, SIC code, industry, type, location (state, Country, Zip), sales level can be searched.

Yet another object of the present invention is to provide a system and method for entity status update which differentiates between business owner and real estate owner status availability.

A further object of the present invention is to provide a system and method for entity status update which is designed to get entities greater awareness, attention, interest, traffic, and interaction to support the entity towards sales and profitability.

A still further object of the present invention is to provide a system and method for entity status update which allows automatic sending of notifications of updates to those who are signed up to receive update notifications of one or more life cycle phase an entity has entered such as: Coming Soon, Grand Opening, New, Moving, Moved, Closing, Closed, Vacant, Sale, Lease.

Still another object of the present invention is to provide a system and method for entity status update which provides for those interested to be able to research the present system if they are not signed up to receive update notifications-access.

Yet another object of the present invention is to provide a system and method for entity status update which provides guidance, partnerships and associations among entities and customers.

A further object of the present invention is to provide a system and method for entity status update which allows for public voice vote from the community.

A still further object of the present invention is to provide a system and method for entity status update which allows entities to have their own pages, where partnership advertising/promotion can occur and to allow their competitor's advertise.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Accordingly, there is provided a system and method for entity status update that maintains the holistic and logical evolution progression of entities life phases captured in categories that lays out the current phase an entity is in and will move into as an “organism” in the market environment. The present invention in accordance to one embodiment of the present invention, function as a guide, repository and real-time alerting system for service availability and opportunities from the life-phase changes experienced by entities to the public, their customers, and partners. In accordance to one embodiment, the type of users of the present invention can be individuals (customers) and organizations: for profit and non-profit, store owner and building/land owner/property management company and government.

According to one embodiment of the present invention, the present invention is made up of two major blocks. One block is for noncommercial real estate. The second block is commercial real estate: Vacant, Sale, Lease. The noncommercial real estate block is what the everyday consumer will be interested/focused on because these status' effect their ability to have or not have a product/service on a particular day or for a particular period, or from a particular business location. The commercial real estate block is for real estate agents and those interested/dealing with land/building concerns. The present invention, deals with both the phases of a business (soft asset) and the hard assets the businesses in the marketplace use such as the land and building business must have to run their business.

According to one embodiment of the present invention, the present invention provides for interconnectedness with “Partners”: Customers, Direct/tight partners, Indirect/Lose partners where Partners are organizations and customers. Interconnectedness is the businesses ability to allow a business to advertise their business/services on their homepage as a trust worthy business because they have done business with them or they are charging them to advertise their business. In accordance to another embodiment of the present invention, the present invention advertises services of businesses that provide services that for example that can help a business prepare for their “Coming Soon” and “Grand Opening”. In yet another embodiment of the present invention, the advertised business can advertise the business they worked with because they had a good relationship during their previous transaction. This is a form of “reviewing” a business in a positive light since a business wouldn't want to be associated with a bad business For example, a business might have their landscaping done by a business and to support their business they can allow them show their business on their page as a partner. An accounting services business would also be shown as their business partner and with all the linking between businesses they could win the business of another business customer or individual customers. Major interconnectedness deals with the players that exists that provide commercial services. One example are construction workers that renovate interiors of businesses such as electricians, plumbers, flooring, roofing, piping, lighting and other services to ready a location for business. Other interconnections are that of businesses buying the inventory of business that go out of business and resell to other businesses at a discount. The present invention links service providers based on the type of phase a business is in so those services are easy to find. This aspect of present invention interconnects one business type to another so service opportunities can be easily found/searched and business transactions are increased. The present invention interconnects all the services business requires as it progresses through its life phases and doesn't have to wonder what business is available to provide the services they need. The interconnectedness of the present invention deals with linking business based on their services type and businesses still/just became available in that service type. The present invention deals with the dynamic environment of the marketplace and highlights which businesses are available as this fact will change in the short and long-run. Business can also have a tight connection with the customers where they directly communicate with them through the present invention to tailor products and services to them.

In another embodiment, the present invention provides for service progression of nonprofits. Customers (clients) need to know the proper service provider very soon before and at least after they have “completed” the service capabilities of their current service provider. For example, many people go to rehabilitation to get their addiction under some control. After their rehabilitation time is up, clients usually go to independent living if they don't have anywhere to go. Clients need a place to find what locations/business to contact after their time with the rehabilitation is over and they are retuned back to “normal” living. The present invention allows to group and order service providers for ease of locating and so clients can know what service providers come before others based on the services they need and what the service providers offer.

In another embodiment, the present invention provides opportunity for announcement. The entity is first communicating that they are going through a transition in their life phase or that they have changed their contact information (telephone number, their URL, Hours of operation). One improvement is that the recipient will welcome the communication because they are interested in knowing/being informed about changes of a particular category. In accordance with one embodiment of the present invention, the information update can come with an advertisement. In another embodiment of the present invention, the update can just be an update so that the public and their customers will be reminded of the business and help increase their business transactions. The present invention is designed to get entities greater visibility, awareness, attention, interest, traffic, interaction to support the entity continue to exist profitably.

Each phase of entity status is a category. The data requires movement based on dates scheduled for the change in status thus the need to move the data to the corresponding phase the entity is currently in. Dates trigger data transfer to keep the data in its current phase so when categories are searched entities are found logically. Entities will not be listed/found in multiple categories as they can't occupy two nonsensical statuses at the same time. But historically speaking entities can be shown where they use to occupy. For example, data in Coming Soon will transfer into Grand Opening and finally into New. An entity in Grand opening will not be in Coming Soon and when it has reached New it will not be in Grand Opening category. Data will move according to the phase an entity is currently transitioning from and into. There are 2-status pairs entities can occupy. For example when an entity is “Moving” the entity is required to occupy one status per location. The entity will occupy a “Moving” status at their current location and occupy a “Coming Soon” status at their future address. The entity will then occupy “Moved” status at their old location and a “Grand Opening” at their new location, which will then turn into a “New” status to complete the sequence.

In another embodiment of the present invention, notification alerts are sent to those that have signed up to receive alerts of new activity from specific life cycle categories. Consumers and organizations will want to know what new businesses are in town. Consumers and other businesses may only want to receive alert-notifications about new businesses in their town/community. Others will want to know which businesses is Moving/has moved and they will sign-up to receive alert-notifications about Moving businesses as the entity wishes to make the Status UpDate Announcement. Notifications will be for customers of businesses and for business service providers that want to know which businesses to contact because they offer services that Moving businesses may need. This is similar to any notification system that updates users about changes/updates they signed-up to receive when changes happen directly related to sales leads.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general architecture of a system that operates in accordance with one embodiment of the present invention;

FIG. 2 illustrates an exemplary web user interface with general features in accordance with one embodiment of the present invention;

FIG. 3 illustrates an exemplary web user interface in the search mode in accordance with one embodiment of the present invention.

### DETAILED DESCRIPTION OF THE INVENTION

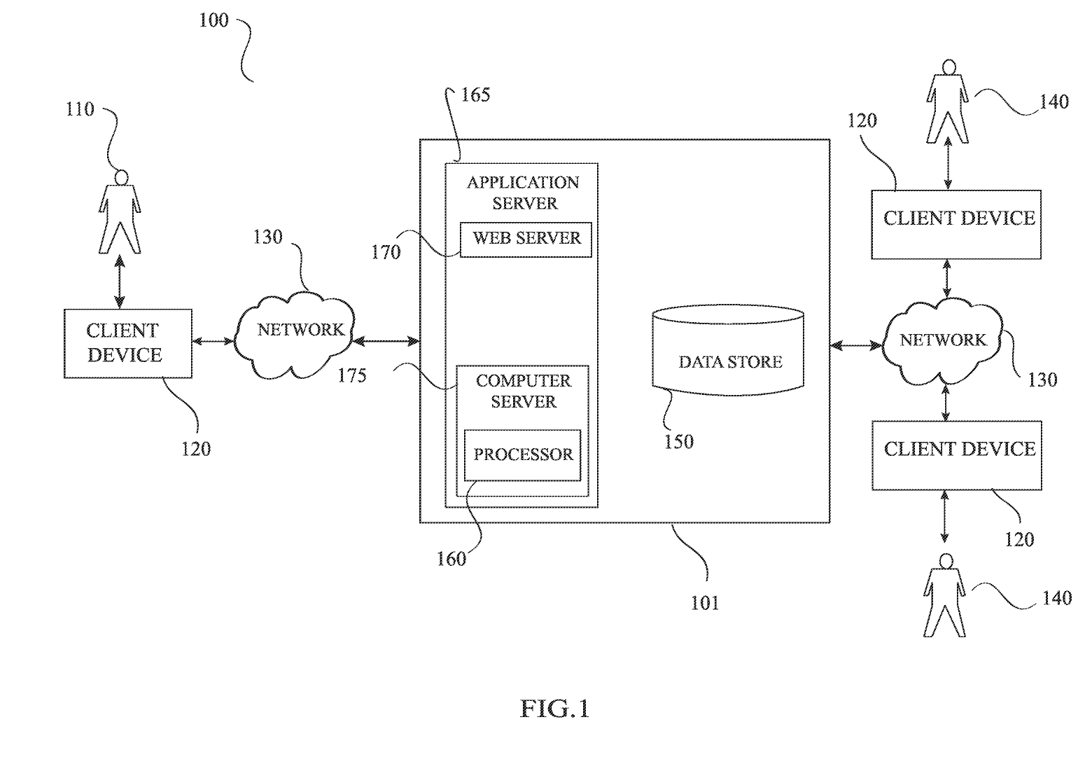

FIG. 1 illustrates the general architecture of entity status system 100 that operates in accordance with one embodiment of the present invention. Hereinafter, the entity status system 100 is also alternatively and interchangeably referred to as Architeckie System 100. Graphical user interface (GUI), also referred to as user interface or web user interface, displays are presented on a plurality of remote client devices 120 connected to a computational device 101 via network 130. The client devices 120 may be any device capable of presenting data and having an input device. The client device 120 may include, but not limited to, personal computers, server computers, mobile devices, tablets, hand-held or laptop devices, smart phones, personal digital assistants or any similar devices. As used herein, the term “network” generally refers to any collection of distinct networks working together to appear as a single network to a user. The term also refers to the so-called world wide “network of networks” i.e. Internet which is connected to each other using the Internet protocol (IP) and other similar protocols. The Internet provides file transfer, remote log in, electronic mail, and other services. As described herein, the exemplary public network 130 of FIG. 1 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1. With respect to the present description, the computational device 101 may include any service that relies on a database system that is accessible over a network, in which various elements of hardware and software of the database system may be shared by one or more users of the Architeckie system (entity status system) 100. To this end, the users of the computational device 101, from which a request or instruction is received over a network 130, may include any Individuals (Customers) Organizations: for profit and nonprofit, Store owner and building/land owner/property management company, individual customer, a group etc. In FIG. 1, users are depicted by 110 and 140. The GUI or web user interface provided by the computational device 101 on the client devices 120 may also be utilized by the users for submitting and retrieving any data to and from the computational system 101

Components appearing in the computational device 101 refer to an exemplary combination of those components that would need to be assembled to create the infrastructure in order to provide the tools and services contemplated by the present invention. As will be apparent to one skilled in the relevant art(s), all of components “inside” of the computational device 101 may be connected and may communicate via a wide or local area network (WAN or LAN).

The computational device 101 includes an application server or executing unit 165 and a data store 150. The application server or executing unit 165 comprises a web server 170 and a computer server 175 that serves as the application layer of the present invention. It would be obvious to any person skilled in the art that, although described herein as the data being stored in a single data store with necessary partitions, a plurality of data stores can also store the various data and files of multiple users.

The Web server 170 is a system that sends out Web pages or web user interfaces containing electronic data files in response to Hypertext Transfer Protocol (HTTP) requests from remote browsers (i.e. browsers installed in the client devices 120 initiated by the users 110 and 140. That is, the Web server 170 provides the user interface to the users of the computational device 101 in the form of Web pages in client devices 120.

The computer server 175 may include a processor 160, a random access memory (RAM) (not shown in figures) for temporary storage of information, and a read only memory (ROM) (not shown in figures) for permanent storage of information. Computer server 175 may be generally controlled and coordinated by an operating system software. The operating system controls allocation of system resources and performs tasks such as processing, scheduling, memory management, networking, and I/O services, among things. Thus, the operating system resides in system memory and executed by CPU coordinates the operation of the other elements of the computational device 101.

Although the description of the computer server 175 may refer to terms commonly used in describing particular computer servers, the description and concepts equally apply to other processing systems, including systems having architectures dissimilar to that shown in FIG. 1.

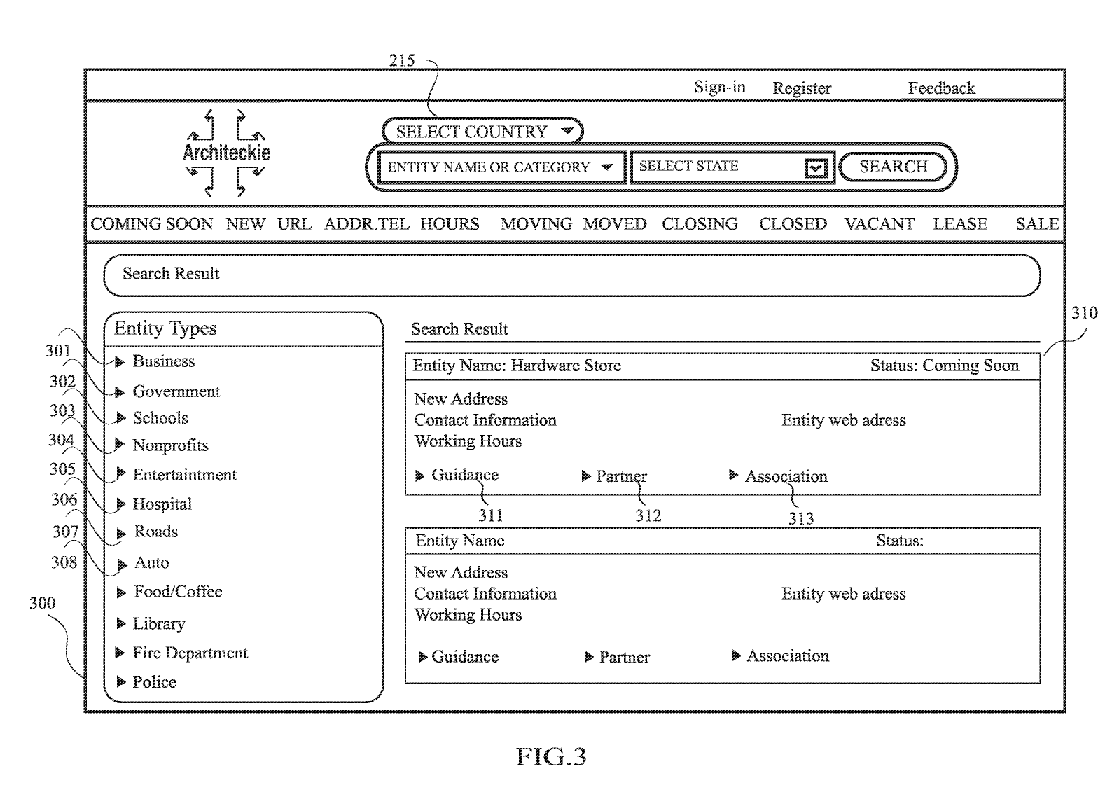

Reference to FIGS. 1, 2 and 3, a user 110, who is representing an entity, say for example a hypothetical hardware store called Hardware Shop, can visit the web user interface presented through an exemplary web page 201 of the Architeckie system (entity status system) 100 displayed on client device 120 and get the Hardware Shop registered with the Architeckie system (entity status system) 100. Hereinafter, a user 110, who is representing an entity, is referred to as entity user 110. In a preferred embodiment of the present invention, on clicking “Register” 217 of web user interface 201, a registration form may be presented to the user 110 whereby necessary marketplace information related to the entity such as legal name of the entity (Hardware Shop in the present example), type of entity (Business in the present example), address, contact information (telephone, URL) etc. can be provided to the Architeckie system (entity status system) 100. The information, once submitted through the user interface, get stored in the data store 150 for further use by the system. In some embodiments, identity of an entity user is required to be verified for getting registered with the Architeckie system (entity status system) 100. This feature helps to ensure that the user is authentic and it has the authorization to update on behalf of the entity the user is representing. A user is able to select the type of entity relevant to his/her entity from a list comprising a plurality of predefined entity types presented on the user interface. Examples of entity types included in the predefined list are, but not limiting to, Business 301, Government 302, Schools 303, Nonprofits 304, Entertainment 305, Hospitals 306, Roads 307, Auto 308 etc. as shown in exemplary web user interface 300 of FIG. 3. In some embodiments, there can be selectable sub-category of entity types made available to the users under a particular main entity type category. For example, under the entity type Business 301, there can be an entity type sub-category Hardware. In the present example user 110 selects entity type Business 301 for Hardware Shop.

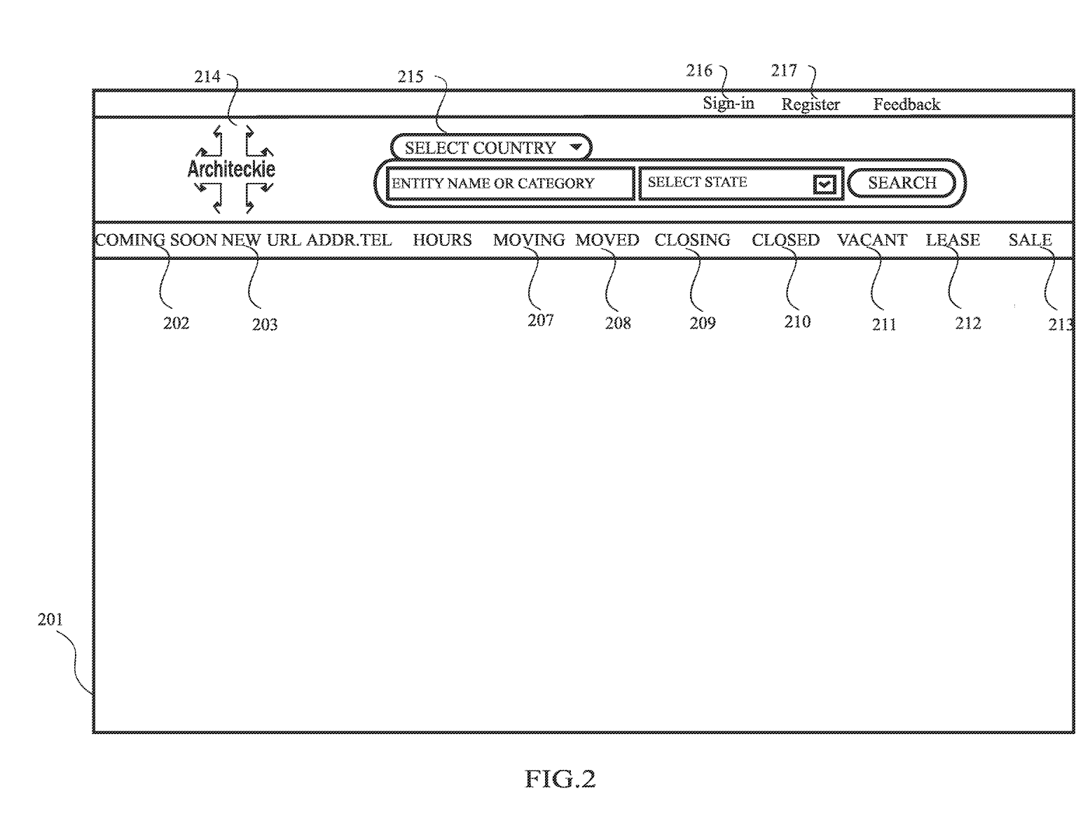

FIG. 2 shows an exemplary web user interface 201 in accordance with an embodiment of the present invention. Symbol 214 is the logo Architeckie of the entity status system 100. Search of an entity in the data store 150 of entity status system can be carried out by a user as per location and entity type/category from box 215.

In a preferred embodiment, an entity user can announce at the Architeckie system (entity status system) 100 one or more updates related to a phase of business life cycle of the entity for which she has got registered with the Architeckie system (entity status system) 100. The user interface may provide a list of a plurality of predefined phases of an entity status life cycle. Example of such predefined entity status information may include, but not limited to, “Coming soon” for an entity going to be opened soon, “Grand Opening” for the occasion of inauguration, “New” for newly opened entity, “Moving” for an entity shifting or about to shift from one place to another, “Moved” for an entity already shifted from one place to another, “Closing” for an entity about to be closed, “Closed” for an entity already closed etc. In the present example, if Hardware Shop is about to open its store at a particular locality, user 110 can select the status “Coming Soon” for it.

Similarly, in a preferred embodiment, an entity registered with the Architeckie system (entity status system) 100 can update other phases of its life cycle whenever that occurs by simply logging on to its account through “Sign In” 216 of web user interface 201 shown in FIG. 2 in the Architeckie system (entity status system) 100 and selecting the relevant status from a dropdown menu.

When a second user 140 visits the user interface provided by the Architeckie system (entity status system) 100 on the client device 120, the second user 140 can view the status and other details of the entities which have provided those information to the Architeckie system (entity status system) 100 of the present invention. Hereinafter, a second user 140 is referred to as customer user 140. A customer user can carry out a search through the user interface by selecting location such as country, state, city, township, locality etc. and/or by selecting entity type category and entity type sub-category from 215 and/or by selecting entity status such as “Coming Soon” 202, “New” 203, “Moving” 207, “Moved” 208, “Closing” 209, “Closed” 210 etc. from the user interface. In the present example, customer user 140 would be able to see under the entity status category “Coming Soon” and entity type category “Business” on the user interface that a new entity Hardware Shop is going to be opened in the locality specified by the user 110. Customer user 140 would also be able to see other details like address, contact number, working days and hours, web address (URL) of the entity Hardware Shop at box 310 on the web user interface 300. If customer user 140 is an entity dealing with electrical works then it may contact entity Hardware Shop to enquire if any electrical work related service is required by Hardware Shop for its new shop to be opened. Similarly, other vendors can also contact Hardware Shop to offer other relevant services. Also, Hardware Shop can also post on its home page provided by the Architeckie system (entity status system) 100 on the web user interface about the services that it may require from different vendors for its new shop. This way Architeckie system (entity status system) 100 provides the opportunity to connect a service seeker with a service provider and vice-versa. The Architeckie system (entity status system) 100 of the present invention makes marketplace communication comprising the one or more updates related to a phase of business life cycle of the entities and the marketplace information available to the users on a single platform in easily searchable way. If customer user 140 is just an individual customer then also it stands benefitted as customer user 140 becomes aware of opening of a new hardware store in its locality if entity Hardware Shop is coming to that locality.

In some other embodiments, customer user 140, who can be a representative of another entity or an individual customer, can become a registered user of the Architeckie system (entity status system) 100 by following steps similar to those described for registration by entity user 110. Once a customer user 140 gets registered with the Architeckie system (entity status system) 100, it can use the Architeckie system (entity status system) 100 like an entity user. Therefore, the term “customer user 140” can also refer to a user who is a customer user as well as an entity user at the same time. Since, a registered entity can have a home page of its own on the web user interface of the Architeckie system (entity status system) 100; one entity can advertise about another entity and/or endorse/review another entity on its own home page on entity status system. This provides the opportunity for “Partnering” among entities on the entity status system which benefits all the stakeholders.

In some embodiments, there can be a partnership between customers and an entity through the Architeckie system (entity status system) 100. Either a customer user or an entity user or both can send “partnership request” to each other simply by clicking on “Partner” option 312 and, on acceptance, a customer or an entity become “partners” of another entity or customer. When an entity makes any change in status of the entity or about any other relevant information in the Architeckie system (entity status system) 100, its “partners” gets updated. This update may be done by the Architeckie system (entity status system) 100 through sending email or mobile message to the “partner” customers. So, if the customer user 140 is a “partner” of entity Hardware Shop, then, customer user 140 would get notified whenever Hardware Shop updates any change in its status or other information like working hours, phone number etc. in the Architeckie system (entity status system) 100. This feature of the present invention ensures that the customers or users are updated in real time or almost in real time. The term “real time” is used to encompass both “real time” and “near real time” or “almost in real time”. Throughout the specification and claims, the term “real time” is intended to mean that the entity status updates can be provided instantaneously to the users through the Architeckie system (entity status system) 100. In other words, any noticeable time delay between upload of entity status by a entity user and availability of that information to a user customer is sufficiently short and, in some cases, the time delay can be so short as to be unnoticeable by a user. The “Guidance” option 311 would lead a customer user to the other service provider(s) registered with the Architeckie system (entity status system) similar to the one shown in the search result i.e. entities similar to Hardware Shop in the present example. Option “Association” 313 is for keeping track of any change in status of an entity by another customer or entity without directly communicating with each other unlike in case of “Partner”. Thus, the Architeckie system (entity status system) brings synergy among the entities through said partnerships.

The entities enlisted in the Architeckie system (entity status system) are always categorized under one category or the other at a time according to the phase of its life cycle as defined by the entity itself. For example, once Hardware Shop opens its store at the new location its status should be “New” and Hardware Shop should be found under the status category “New”. If Hardware Shop plans to move from one place to another, then it should be categorized under status “Moving” and “Coming Soon” at their new location. It is ensured that an entity does not remain under more than one category of phase at the same time so that confusion does not arise. However, in a preferred embodiment, option is provided on the user interface for viewing status update history of a registered entity for a specific period. For example, history of the entity Hardware Shop may reveal where it was in the last months, year and years before its current status.

In some preferred embodiment, the status update of an entity registered with Architeckie system (entity status system) 100 can be initiated by a trigger. For example, Hardware Shop may set to change its status automatically to “Grand Opening” on the entity status system after 30 days of announcing its status as “Coming Soon”. In this case, after elapse of 30 days, Architeckie system (entity status system) would categorize Hardware Shop under the status category “Grand Opening” and remove its status from the category “Coming Soon” and, accordingly, Architeckie system (entity status system) would notify the “partners” of Hardware Shop about this transition or change of status.

In some embodiments, Architeckie system (entity status system) categorizes the entities based on the logical sequence of services/products those entities offer. For example, plumbing service may be required after a customer buys a sanitary ware from the Hardware Shop and, hence, Architeckie system (entity status system) would categorize plumbing service providers on the user interface in such a way that, the customer can easily find plumbing service providers registered with the Architeckie system (entity status system). Similarly, Hardware Shop can be categorized after another category, for example, after a category named “Construction Material” because of the logic that hardware items are required while constructing a commercial space. Alternatively, all the above mentioned three types of entities—hardware store, plumbing service providers and construction material supplier can be organized as sub-categories under a single category, say for example a category named “Business Services”.

The nonprofit organizations can also be categorized in the Architeckie system (entity status system) according to the type and availability of services offered by the nonprofits in accordance with one embodiment of the present invention. For example, under the category “Nonprofits” 304, there can be sub-categories such as “Art, Culture and Humanities”, “Education and Research”, “Health”, “Human Services” etc. each of which may contain name and contact information of nonprofits organized in a logical sequence of service that a person may seek from the nonprofits.

Architeckie system (entity status system) can, in some embodiments, segregate real estate owners registered with the Architeckie system (entity status system) into a Commercial Real Estate category within the Architeckie system (entity status system). In this embodiment, users can make use of status such “Lease” 212, “Sale” 213 etc. shown in the web user interface 201 of FIG. 2. A land/building owner registered with Architeckie system (entity status system) can announce on the Architeckie system (entity status system) for sale or lease of his/her commercial real estate. However, a real estate owner is not allowed to use the status “Vacant” 211 for his/her property if it houses any business. The status “Vacant” can be used only when the real estate does not house any business at that time. The status “Vacant” is overseen by the administrator of the Architeckie system (entity status system).

Architeckie system (entity status system) of the present invention may also offer a platform for community voting in some embodiments which helps in assessing marketplace demand and in identifying opportunities. For example, a community from a particular locality may express their desire to have a confectionery store in their locality through online voting on the platform provided by Architeckie system (entity status system). This would help a business to gauge the market potential before making a decision.

In some embodiments, a mobile app enables one or more users to do various tasks related to the Architeckie system (entity status system) of the present invention. The mobile application or “app” is a computer program that may be downloaded and installed in client device 120 using methods known in the art. The mobile app enables a client device 120, such as a smart phone, to interact with the Architeckie system (entity status system) and also to present a user interface at the client device to enable a user to use the various functions provided by the Architeckie system (entity status system).

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a processor” or “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to data store, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims.

What is claimed is:

1. A method for a marketplace communication through an entity status system, said system comprising one or more client devices and a computational device communicatively connected to said one or more client devices through a network, said computational device having one or more data stores and one or more processors, said method comprising:
providing a user interface by said computational device on said one or more client devices through said network;
uploading said marketplace communication by an entity user or an administrator to said one or more data stores through said user interface; and
sharing of said marketplace communication with one or more customer users through said entity status system;
wherein, said marketplace communication provides said one or more customer users in real time one or more updates related to a business life cycle of one or more entities and one or more marketplace information.

2. The method as in claim 1, wherein said one or more updates include a status update related to a phase of said business life cycle of said one or more entities.

3. The method as in claim 2, wherein said phase of said business life cycle of said one or more entities is selected from a list comprising a plurality of predefined phases provided through said user interface for said status update.

4. The method as in claim 3, wherein said plurality of predefined phases are Coming Soon, Grand Opening, New, Moving, Moved, Closing, Closed, Vacant, Sale and Lease.

5. The method as in claim 1, wherein said user interface enables searching of historical archive of said marketplace communication for said one or more entities.

6. The method as in claim 1, wherein said one or more entities are categorized as an entity type selected from a list having a plurality of predefined entity types.

7. The method as in claim 1, wherein said one or more entities are categorized based on a logical sequence of service or product offered by said one or more entities on said user interface.

8. The method as in claim 1, wherein said marketplace information includes endorsement or advertisement or review of an entity by another entity of said one or more entities through a home page belonging to said another entity hosted on said user interface.

9. The method as in claim 1, wherein said one or more customer users or said entity user staying in partnership with said one or more entities through said entity status system automatically receives in real time said marketplace communication relevant to said one or more entities.

10. The method as in claim 1, wherein said user interface enables said one or more customer users or said entity user to track said marketplace communication for said one or more entities through said entity status system by being in association with said one or more entities.

11. The method as in claim 1, wherein said marketplace communication for similar type of entities from said one or more entities are made available under a single category for providing guidance to said one or more customer users to find said similar type of entities.

12. The method as in claim 1, wherein said user interface enables community voting among said one or more customer users to express an opinion on a marketplace demand.

13. An entity status system for a marketplace communication, said system comprising:
one or more client devices having data input and data display options; and
a computational device communicatively connected to said one or more client devices through a network, said computational device having one or more data stores and an executing unit including at least one processor, the executing unit configured to, at least;
provide a user interface on said one or more client devices;
allow an entity user or an administrator to upload one or more updates related to a business life cycle of one or more entities and one or more marketplace information through said user interface to the said one or more data stores; and
enable retrieval of said one or more updates and said marketplace information from said one or more data stores for sharing with one or more customer users;
wherein, said one or more updates related to said business life cycle of said one or more entities or said one or more marketplace information enable said one or more customer users to get said marketplace communication in real time.

14. The system as in claim 13, wherein said one or more updates include a status update related to a phase of said business life cycle of said one or more entities.

15. The system as in claim 14, wherein said phase of said business life cycle of said one or more entities is selected from a list comprising a plurality of predefined phases provided through said user interface for said status update.

16. The system as in claim 15, wherein said plurality of predefined phases are Coming Soon, Grand Opening, New, Moving, Moved, Closing, Closed, Vacant, Sale and Lease.

17. The system as in claim 13, wherein said user interface enables searching of historical archive of said marketplace communication for said one or more entities.

18. The system as in claim 13, wherein said one or more entities are categorized as an entity type selected from a list having a plurality of predefined entity types.

19. The system as in claim 13, wherein said one or more entities are categorized based on a logical sequence of service or product offered by said one or more entities on said user interface.

20. The system as in claim 13, wherein said user interface is provided through a mobile application.
